(19) United States
(12) Patent Application Publication
(10) Pub. No.: US 2024/0288648 A1
(43) Pub. Date: Aug. 29, 2024

(54) OPTICAL DISTRIBUTION BOX CONFIGURED TO PROVIDE WATER-RESISTANT ENCLOSURE

(71) Applicant: PPC BROADBAND, INC., East Syracuse, NY (US)

(72) Inventors: Subin PANAKKAL SADASIVAN, Ernakulam (KL) (IN); Icy Kollielil VARGHESE, Tripunithura (KL) (IN); Boby ANTONY, Kochi (KL) (IN); Archana Raj MARY, Ernakulam (KL) (IN); Abilash NEVILLE, Ernakulam (KL) (IN); Afzal V. ABDULSALAM, Ernakulam (KL) (IN); Sandeep PULIYANKULANGARA, Ernakulam (KL) (IN); Beevi MOHAMMEDALI, Aluva (KL) (IN); Ceegan Alex FRANCIS, Alappuzha (KL) (IN); Toji THOMAS, Pune (MH) (IN)

(73) Assignee: PPC BROADBAND, INC., East Syracuse, NY (US)

(21) Appl. No.: 18/586,078

(22) Filed: Feb. 23, 2024

Related U.S. Application Data
(60) Provisional application No. 63/463,585, filed on May 3, 2023.

(30) Foreign Application Priority Data
Feb. 24, 2023 (IN) 202321012607

(51) Int. Cl. G02B 6/44

(52) U.S. Cl. CPC G02B 6/44465

(57) ABSTRACT

An optical distribution box includes a base portion, a cover portion, and an engaging portion configured to be attached to a first one of the base portion and the cover portion. A second one of the base portion and the cover portion comprises an angled pathway portion; at least a portion of a seal portion is located between the angled pathway portion and the first one of the base portion and the cover portion; the angled pathway portion transitions from a first portion to a second portion; an edge portion of the engaging portion is configured to engage the first portion and the second portion of the angled pathway portion; and the slide body portion is configured to urge the cover portion toward the base portion in a location of the seal portion so as to enhance a watertight seal between the cover portion and the base portion.

### CROSS-REFERENCE TO RELATED APPLICATION

This application claims the benefit of India Provisional Patent Application No. 202321012607, filed Feb. 24, 2023, and U.S. Provisional Application No. 63/463,585 filed May 3, 2023, which are currently pending, the disclosures of which are hereby incorporated by reference herein in their entireties.

### BACKGROUND

The present invention relates generally to optical fiber distribution boxes. More particularly, the present invention relates to optical fiber distribution boxes having a waterproof or water resistant secure closure mechanism and improved capacity.

Examples of conventional optical fiber distribution boxes (OBDs) have complex water-resistant closure mechanisms and have limited capacity for a given size. ODBs can have complicated input and output glands, no particular way to route cables inside the box, and no scalability of splice trays and splitters. Inline closures and dome closures are heavy and rugged. These closures are very difficult to handle and rework. The rugged and complex outside configuration of many ODBs catches a lot of mud when buried and, as a result, these boxes often have to be washed off in order to work on these boxes comfortably.

There is a need for an optical distribution box that has a simple and secure waterproof or water resistant closure mechanism, has more efficient use of interior space so as to provide more capacity, has an outside design that is less prone to catch mud, and is light weight and simple to handle.

### SUMMARY

The present disclosure provides a much needed waterproof ODB that provides increased module/tray density in a compact form.

Embodiments are IP68 rated. Embodiments can be used as an inline closure or a dome closure. Embodiments feature standard gland cables which are IP68 rated and commonly used in standard ODBs, inline closures and dome closures, and custom-made pass-through cable gland as in inline closures and Dome closures. Embodiments have predefined routing paths, and plug and play lockable modules for splitters and splices. Embodiments are scalable and can take more density than existing configurations. Embodiments feature sliding clip locks for IP55 protection and have sliding ramps with tool free winged bolts to achieve an IP68 rating. Embodiments feature a 216 B lock, when the clip lock is not required. Embodiments feature a simple screw 216 C lock, clip lock, clip sliding lock, and screw tightening for waterproof IP68 rating. Embodiments use standard glands that are easily available and interchangeable, have specific routing paths for easy routing, lockable and scalable splitter/splicing module for plug and play type operation, and have provision for splitters, splice trays and adapter panels.

Embodiments provide a slide body that when in a fully engaged position presses the cover onto the base to provide a watertight seal between the cover and the base, and an angled mounting bracket that enables connector modules and/or splice trays to be positioned such that the connector modules and/or splice trays are accessible and enables a high module/tray density.

Embodiments provide an optical distribution box having a slide body portion that may be configured to urge a cover portion toward a base portion in a location of a seal portion so as to enhance a watertight seal between the cover portion and the base portion in a fully engaged position of the slide body portion.

Embodiments provide an optical distribution box, comprising: a base portion; a cover portion configured to be attached to the base portion; an engaging portion configured to be slidingly attached to a first one of the base portion and the cover portion; and a securing portion configured to secure the engaging portion to one of the base portion and the cover portion in a fully engaged position. A seal portion may be configured to be located between the cover portion and the base portion; a second one of the base portion and the cover portion may comprise an angled pathway portion; at least a portion of the seal portion may be located between the angled pathway portion and the first one of the base portion and the cover portion; the cover portion may be configured to be hingedly attached to the base portion; the cover portion may be structurally configured to provide access to the interior of the base portion when the cover portion is in an open position; the cover portion may be structurally configured to prevent access to the interior of the base portion when the cover portion is in a closed position; the angled pathway portion may comprise a first portion and a second portion; the angled pathway portion may transition from the first portion to the second portion; the engaging portion may comprise a slide body portion that may be configured to slide from the first portion to the second portion; the slide body portion may comprise an edge portion that may be configured to engage the first portion and the second portion of the angled pathway portion; the slide body portion may be configured to urge the cover portion toward the base portion when the slide body portion is moved from the first portion to the second portion; and the slide body portion may be configured to urge the cover portion toward the base portion in a location of the seal portion so as to enhance a watertight seal between the cover portion and the base portion in the fully engaged position of the slide body portion.

In embodiments, the securing portion may be fixed to the engaging portion.

In embodiments, the securing portion may be configured as an integral part of the engaging portion.

In embodiments, the edge portion of the slide body portion may comprise a first edge portion, and the slide body portion may comprise a second edge portion.

In embodiments, the first one of the base portion and the cover portion may comprise a second edge portion receiving portion that may be configured to receive the second edge portion of the slide body portion.

In embodiments, the second edge portion receiving portion may be configured to permit the second edge portion to rotate relative to the first one of the base portion and the cover portion so as to alternatively position the angled pathway portion between the first edge portion and the second edge portion.

In embodiments, movement of the slide body portion from the first portion to the second portion of the angled pathway portion may compress the seal portion between the cover portion and the base portion.

In embodiments, the optical distribution box may further comprise an angled mounting bracket configured to be attached to an interior of the base portion.

In embodiments, the angled mounting bracket may comprise a base plate configured to be attached to an interior wall of the base, the angled mounting bracket may comprise an angled extension that extends from the base plate at an angle between zero degrees and ninety degrees, and the angled extension may be configured to receive a mount that is configured to receive a plurality of modules and/or trays.

Embodiments provide an optical distribution box, comprising: a base portion; a cover portion configured to be attached to the base portion; an engaging portion configured to be attached to a first one of the base portion and the cover portion; and a seal portion configured to be located between the cover portion and the base portion. A second one of the base portion and the cover portion may comprise an angled pathway portion; at least a portion of the seal portion may be located between the angled pathway portion and the first one of the base portion and the cover portion; the angled pathway portion may transition from a first portion to a second portion; an edge portion of the engaging portion may be configured to engage the first portion and the second portion of the angled pathway portion; the engaging portion may be configured to urge the cover portion toward the base portion when the engaging portion is moved from the first portion to the second portion; and the engaging portion may be configured to urge the cover portion toward the base portion in a location of the seal portion so as to enhance a watertight seal between the cover portion and the base portion in a fully engaged position of the engaging portion.

In embodiments, the optical distribution box may further comprise a securing portion that may be configured to secure the engaging portion to one of the base portion and the cover portion in the fully engaged position.

In embodiments, the cover portion may be configured to be hingedly attached to the base portion.

In embodiments, the cover portion may be structurally configured to provide access to the interior of the base portion when the cover portion is in an open position, and the cover portion may be structurally configured to prevent access to the interior of the base portion when the cover portion is in a closed position.

In embodiments, the engaging portion may comprise a slide body portion configured to slide from the first portion to the second portion of the angled pathway portion.

In embodiments, the slide body portion may comprise an edge portion configured to engage the first portion and the second portion of the angled pathway portion.

In embodiments, the edge portion of the slide body portion may comprise a first edge portion, and the slide body portion may comprise a second edge portion.

In embodiments, the first one of the base portion and the cover portion may comprise a second edge portion receiving portion that may be configured to receive the second edge portion of the slide body portion, and the second edge portion receiving portion may be configured to permit the second edge portion to rotate relative to the first one of the base portion and the cover portion so as to alternatively position the angled pathway portion between the first edge portion and the second edge portion.

Embodiments provide an optical distribution box, comprising: a base portion; a cover portion configured to be attached to the base portion; and an engaging portion configured to be attached to a first one of the base portion and the cover portion. A second one of the base portion and the cover portion may comprise an angled pathway portion; the base portion and the cover portion may be configured to receive a seal portion so that at least a portion of the seal portion is located between the angled pathway portion and the first one of the base portion and the cover portion; the angled pathway portion may transition from a first portion to a second portion; an edge portion of the engaging portion may be configured to engage the first portion and the second portion of the angled pathway portion; and the slide body portion may be configured to urge the cover portion toward the base portion in a location of the seal portion so as to enhance a watertight seal between the cover portion and the base portion.

In embodiments, the first portion is thinner in a first direction than the second portion.

In embodiments, the engaging portion may comprise a slide body portion.

In embodiments, the slide body portion may be configured to urge the cover portion toward the base portion when the slide body portion is moved from the first portion to the second portion.

In embodiments, the optical distribution box further comprises a securing portion that may be configured to secure the engaging portion to one of the base portion and the cover portion in a fully engaged position.

In embodiments, the securing portion may comprise a winged bolt and a nut, the nut is fixed to the slide body portion, and the slide body portion is pulled toward the thick portion of the angled pathway by the securing portion engaging the nut.

In embodiments, the slide body portion may comprise a first edge portion that may be configured to engage the first portion and the second portion of the angled pathway portion, and the slide body portion comprises a second edge portion.

In embodiments, the first one of the base portion and the cover portion may comprise a second edge portion receiving portion that may be configured to receive the second edge portion of the slide body portion, and the second edge portion receiving portion may be configured to permit the second edge portion to rotate relative to the first one of the base portion and the cover portion so as to alternatively position the angled pathway portion between the first edge portion and the second edge portion.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a front perspective view of an optical distribution box in accordance with various aspects of the disclosure.

FIG. 2 is a bottom rear perspective view of the optical distribution box of FIG. 1.

FIG. 3 is a front perspective view of the optical distribution box of FIG. 1 in an open state and with connector modules in a pivoted position and splice trays in a stored position.

FIG. 4 is a front view of the optical distribution box of FIG. 1 in the position shown in FIG. 3.

FIG. 5 is a front perspective view of the optical distribution box of FIG. 1 in an open state and with connector modules in a stored position and splice trays in a stored position.

FIG. 6 is a perspective view of a base of the optical distribution box of FIG. 1 with no connector modules and no splice trays.

FIG. 7 is a perspective view of an angled mounting bracket in accordance with various aspects of the disclosure with mounting modules connected to the angled mounting bracket.

FIG. 8 is a perspective view of the angled mounting bracket of FIG. 7.

FIG. 9 is a perspective view of an optical distribution box in accordance with various aspects of the disclosure.

FIG. 10 is a front view of an optical distribution box in accordance with various aspects of the disclosure.

FIG. 11 is a partial perspective view of two slide clip closures in accordance with various aspects of the disclosure.

FIG. 12 is a partial perspective view of an angled ramp in accordance with various aspects of the disclosure.

FIG. 13 is a perspective view of two of the angled ramps of FIG. 12.

FIG. 14 is a partial perspective view of a slide clip mechanism in accordance with various aspects of the disclosure in an open position.

FIG. 15 is a partial perspective view of the slide clip mechanism of FIG. 14 in a partially closed position.

FIG. 16 is a perspective sectional view of the slide clip mechanism of FIG. 14.

FIG. 17 is a perspective view of the angled ramp of FIG. 12.

FIG. 18 is a perspective sectional view of the slide clip mechanism of FIG. 14 in a fully closed position.

FIG. 19 is a perspective view of the slide clip mechanism of FIG. 14 in a fully closed position and with a fastener installed.

FIG. 20 is a second perspective view of the slide clip mechanism of FIG. 14 in a fully closed position and with a fastener installed.

### DETAILED DESCRIPTION OF EMBODIMENTS

Embodiments provide an optical distribution box having a slide body portion that may be configured to urge a cover portion toward a base portion in a location of a seal portion so as to enhance a watertight seal between the cover portion and the base portion in a fully engaged position of the slide body portion.

Embodiments provide a slide body that when in a fully engaged position presses the cover onto the base to provide a watertight seal between the cover and the base, and an angled mounting bracket that enables connector modules and/or splice trays to be positioned such that the connector modules and/or splice trays are accessible and enables a high module/tray density.

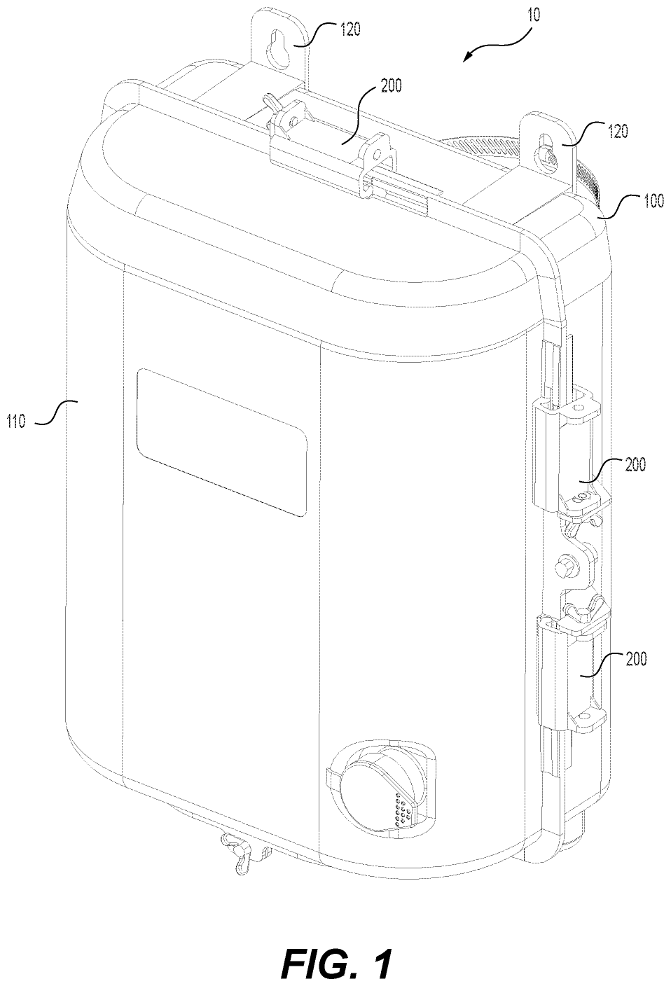

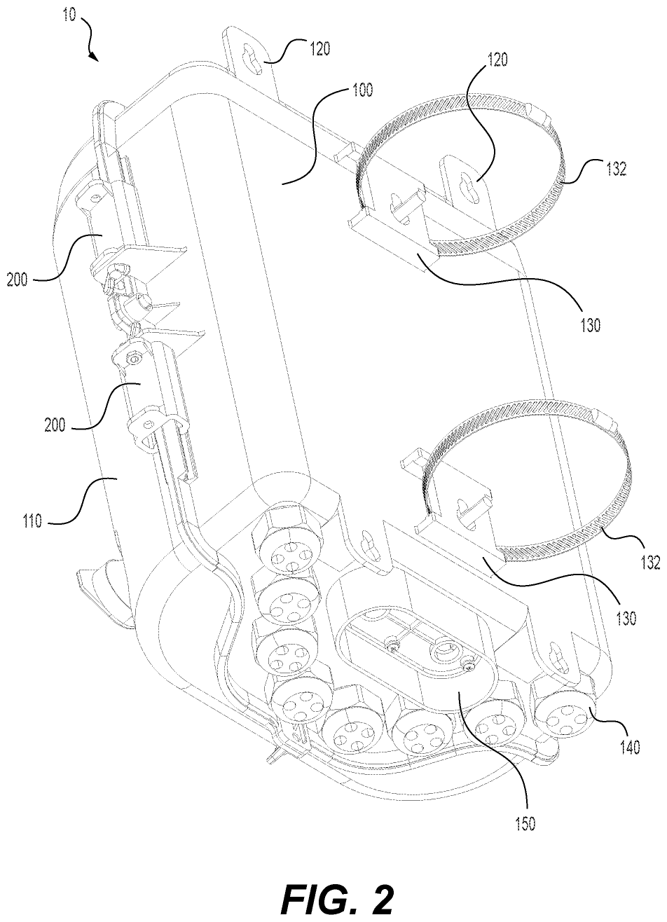

FIGS. 1 and 2 show an exemplary optical distribution box (ODB) 10 in accordance with various aspects of the disclosure. In this example, ODB 10 has a base portion, for example, a base, 100 and a cover portion, for example, a cover, 110. The cover 100 is attached to the base 100 by way of a hinge mechanism. In other embodiments, the cover 100 is attached to the base 110 by way of a non-hinged attachment mechanism such as a snap fit and/or one or more engaging portions, for example, slide clips, 200 (described in more detail below). In this example, the base 100 has two mounting portions, for example, mounting brackets, 120 extending from an upper side of the base 110, and two mounting portions, for example, mounting brackets, 130 extending from a back surface of the base 110. The mounting brackets 130 are configured to receive a strap 132 for attaching the ODB 10 to a pole or other cylindrical structure. In this example, the ODB 10 has a plurality of (in this example, eight) cable/fiber receiving portions, for example, ports, 140 located on a bottom of the ODB 10. The ports 140 are configured to provide waterproof or water resistant entry and/or exit of cables from the ODB 10. Other embodiments have fewer or more of the ports 140. In this example, the ODB 10 has a plurality of (in this example, two) cable/fiber receiving portions, for example, ports, 150 located on a bottom of the ODB 10. The ports 150 are configured to provide water-proof or water-resistant entry and/or exit of cables from the ODB 10.

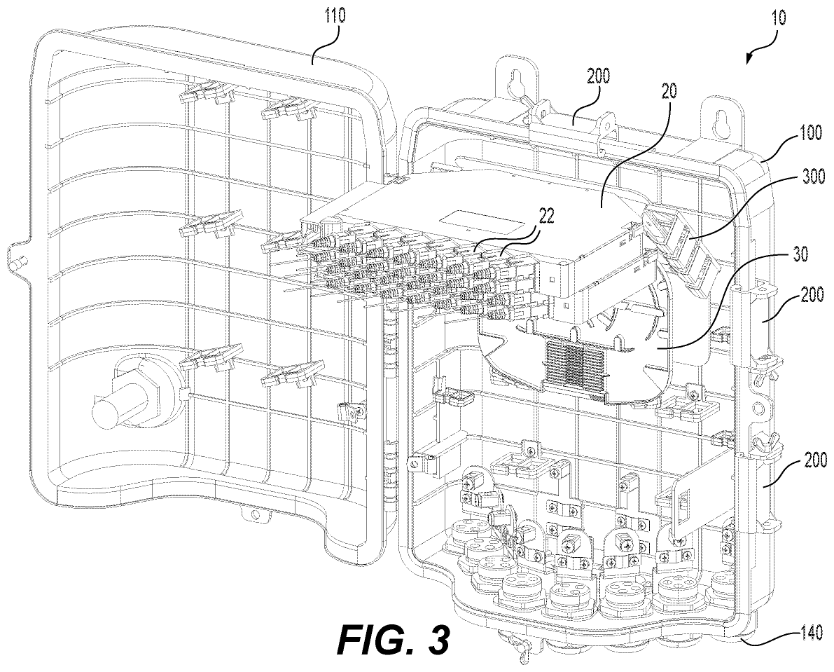

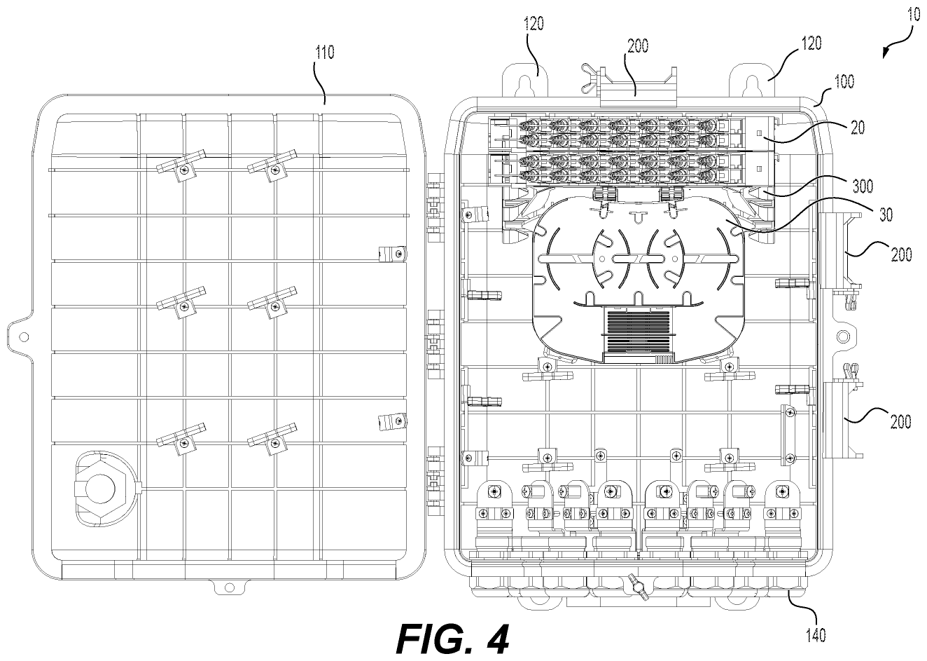

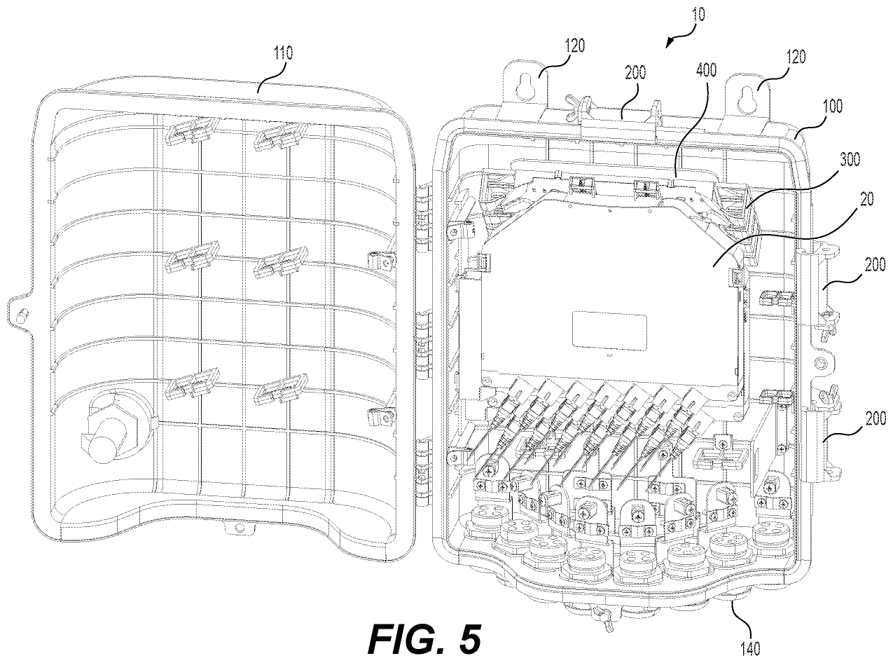

FIGS. 3-5 show examples of internal components of the ODB 10. FIG. 3 shows ODB 10 in an open position with a plurality of (in this example two) connector modules 20 pivotably attached to one or more mounts 300. Also shown in FIG. 3, are a plurality of splice trays 30 pivotably attached to one or more of the mounts 300. In FIG. 3, the splice trays 30 are in a down or stored position in which the splice trays hang vertically from the mounts 300. In FIG. 3, the connector modules 20 are in an up or pivoted position in which the connector modules 20 extend horizontally out of the base 100 of the ODB 10. The up or pivoted position provides easier access to the connector modules 20 and provide access to the splice trays 30. FIG. 4 is a front view of the condition shown in FIG. 3. That is, ODB 10 is in an open position with the connector modules 20 in the up or pivoted position and the splice trays 30 in the down or stored position. FIG. 5 shows the ODB 10 in the open position with both the connector modules 20 and the splice trays 30 in the stored position. In the condition shown in FIG. 5, the cover 110 can be rotated into contact with the base 100 to close the ODB 10.

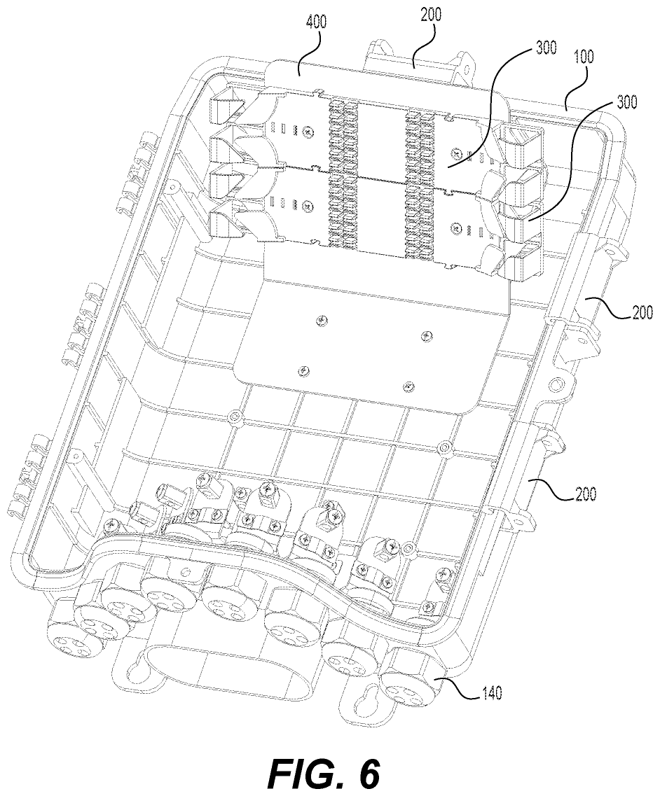

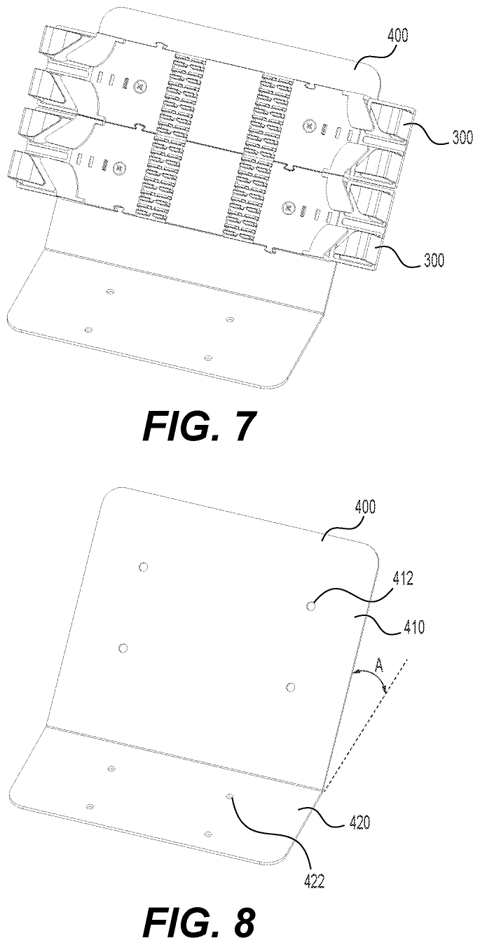

FIG. 6 shows the base 100 of the ODB 10 with the cover 110 removed and no connector modules 20 or splice trays 30. In this condition, the mounts 300 (in this example, two) are shown attached to an angled mounting bracket 400. The angled mounting bracket 400 is attached to a back wall of the base 100. In this example, each of the mounts 300 is configured to receive a plurality of the connector modules 20 and/or the splice trays 30. In other examples, fewer or more of the mounts 300 (or mounts of a different configuration) can be attached to the angled mounting bracket 400. FIG. 7 shows the angled mounting bracket 400 and the mounts 300 removed from the ODB 10. FIG. 8 shows the angled mounting bracket 400 with no mounts attached. In this example, the angled mounting bracket 400 has an extension 410 that extends at an angle A from a base plate 420. In embodiments, the angle A at which the extension 410 extends from the base plate 420 is greater than zero degrees and less than 90 degrees. Because, in this example, the base plate is attached to a vertical back wall of the base 100, angle A causes the extension 410 to extend at an angle relative to vertical, which results in the connector modules 20 and the splice trays 30 hanging down vertically from the extension 410. The angled stacking of the connector modules 20 and the splice trays 30 that results from the angled position of the extension 410 offsets the front edges of each of the connector modules 20 and each of the splice trays 30 from each other. This offset facilitates selecting the desired one of the connector modules 20 and the splice trays 30 to move from the stored position to the pivoted position. The offsetting of the front edges also facilitate access to connectors 22 connected to the connector modules 20 (as shown in FIG. 3).

FIG. 8 shows a plurality of holes 412 in extension 410 that are configured to be used to attach the mounts 300 to the extension 410. FIG. 8 also shows a plurality of holes 422 in the base plate 420 that are configured to be used to attach the angled mounting bracket 400 to the base 100.

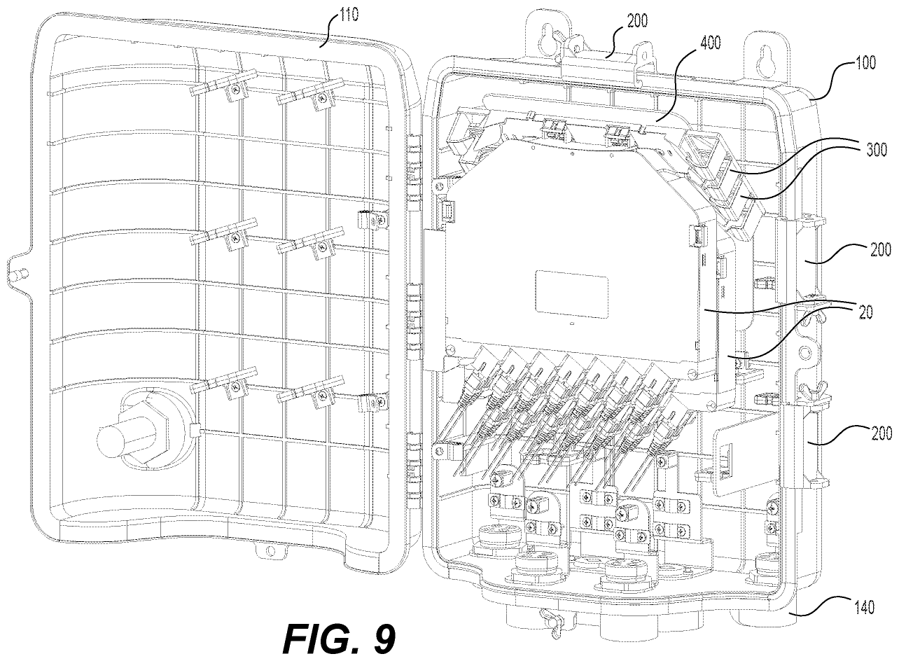

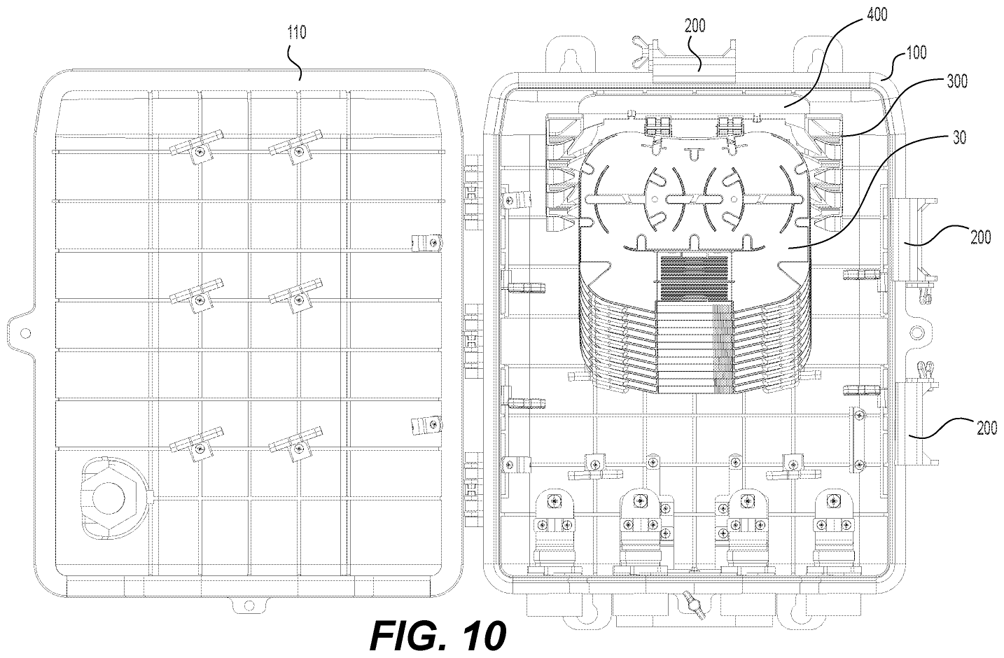

FIG. 9 shows an example of ODB 10 that has four ports 140 and includes two connector modules 20 and no splice trays. FIG. 10 shows an example of the ODB 10 shown in FIG. 9, but with a plurality of splice trays 30 and no connector modules. In these and other examples, the mounts 400 are configured to receive the connector modules 20, the splice trays 30, or a combination of both, as well as other modules and trays.

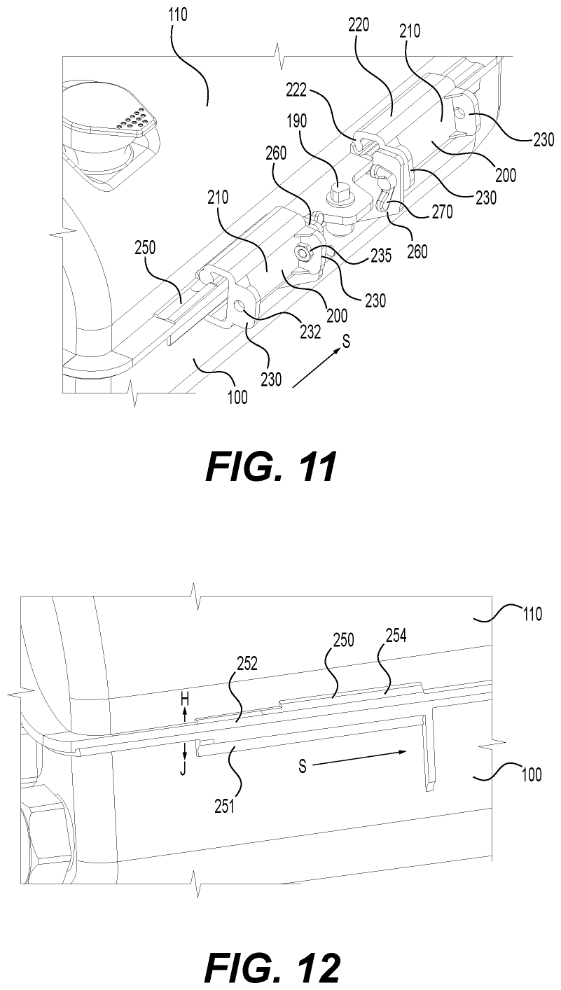

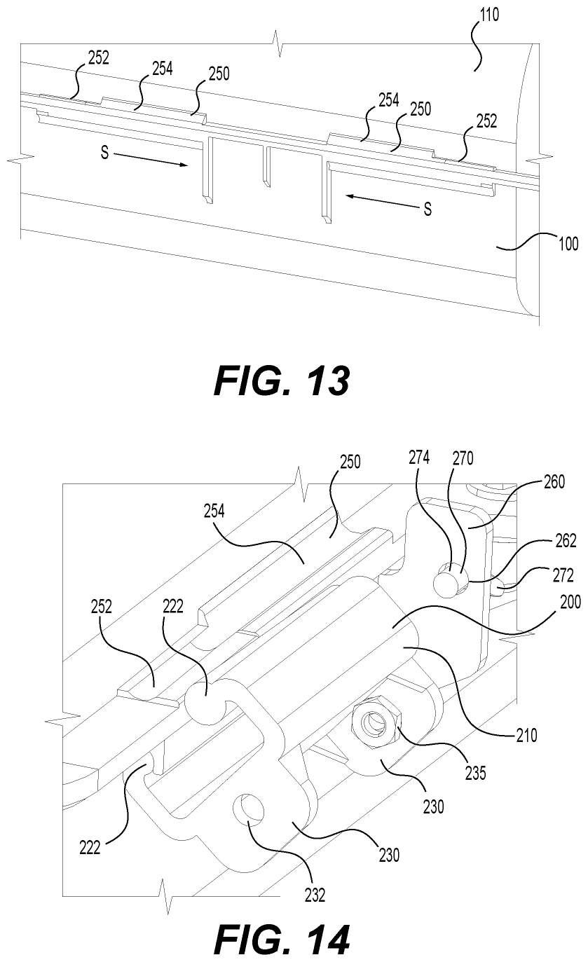

FIG. 11-20 show an example of the slide clips 200 that are configured to securely maintain the cover 110 in a waterproof, closed position on the base 100. FIG. 11 shows each of the slide clips 200 having slide body 210 that engages an angled pathway portion, for example, an angled pathway, 250. The interaction between the slide body 210 and the angled pathway 250 results in the cover 110 being pressed securely onto the base 100 of the ODB 10. FIGS. 12 and 13 show an example of the angled pathway 250 having a first portion, for example, a thin section, 252 and a second portion, for example, a thick section, 254. A height H of the angled pathway 250 increase from the thin section 252 to the thick section 254 in the direction of arrow S in FIG. 12. In embodiments, a second edge portion receiving portion, for example, a lower pathway, 251 on base 100 is a constant height J and as a result the combined height H and J increase in the direction of arrow S. As shown in FIG. 14, slide body 210 has two opposed edges 222. An upper edge, for example, a first edge, of the edges 222 engages the angled pathway 250 and a lower edge, for example, a second edge, of the edges 222 engages the lower pathway 251. Due to the combined height of the angled pathway 250 and the lower pathway 251 increasing in the direction of arrow S, the cover 110 is pressed securely onto the base 100 as the slide body 210 is moved in the direction of arrow S.

FIG. 11 shows two of the slide bodies 210 that slide in opposite directions (both toward a bolt 190 that secures the cover 110 to the base 100 in the closed position). FIG. 1 shows one of the slide clips 200 on an upper side of the ODB 10. Other embodiments have fewer or more of the slide clips 200.

FIG. 11 shows the slide body 210 having an end plate 230 at each end of the slide body 210. Each end plate 230 has a hole 232 or other receiving feature for receiving a locking device 270. In this example, the locking device 270 is a winged bolt. In this example, a lock plate 260 extends from the base 100 and is configured to receive the winged bolt 270. As best shown in FIG. 14, the winged bolt 270 has a threaded shaft 274 that is configured to extend through a hole 262 in the lock plate 260 and through the hole 232 in the end plate 230. In this example, a nut 235 is provided to engage the threaded shaft 274 such that tightening the winged bolt 270 (by rotating wings 272) into the nut 235 draws the slide body 210 along the direction of arrow S, which presses the cover 110 onto the base 100. In this example, the nut 235 is fixed to the end plate 230 so that no wrench or other holding tool is needed to hold the nut 235 when the winged bolt 270 is rotated into the nut 235.

In this example, the slide clip 210 is symmetrically formed so that the same slide clip 210 can be used regardless of the direction in which is slides to tighten the slide clip 200.

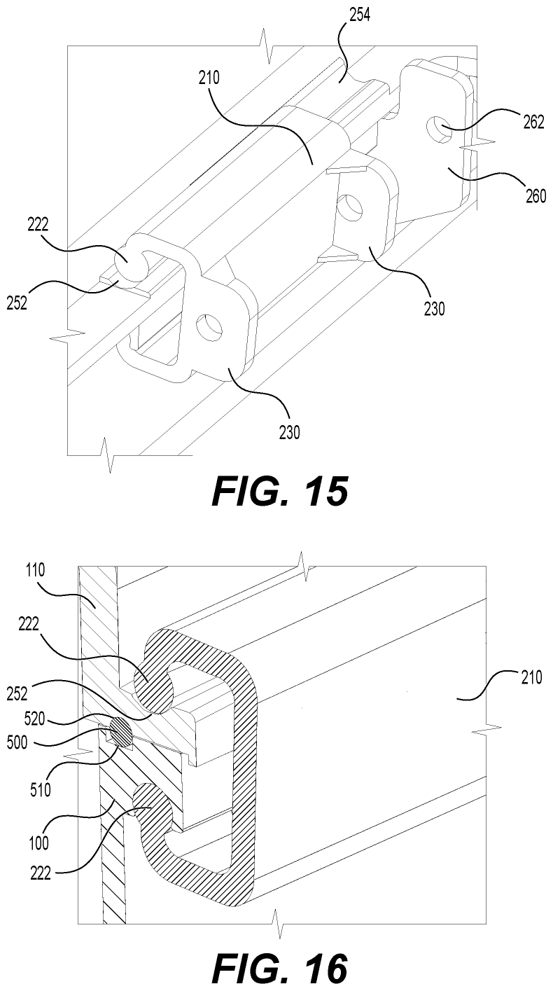

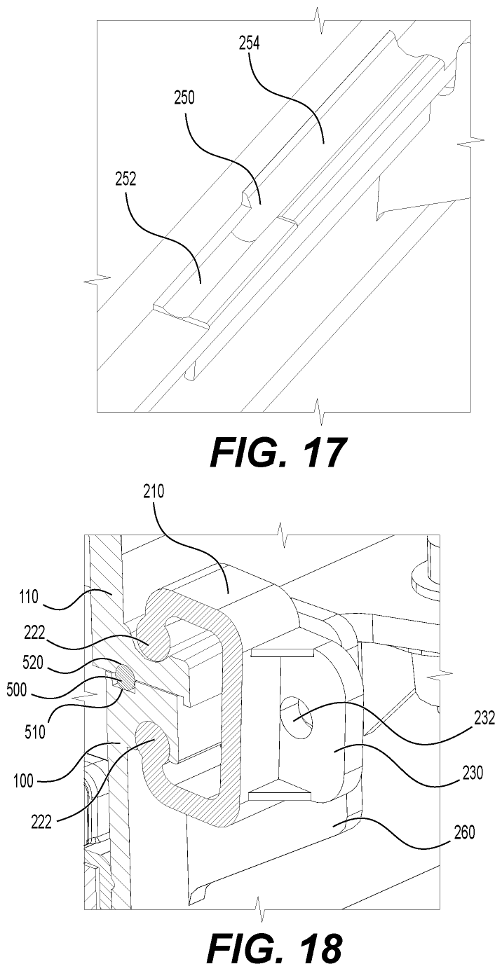

FIG. 15 shows the slide body 210 in a position in which it is engaging the thin section 252 of the angled pathway 250 and partially engages the thick section 254 of the angled pathway 250. In this position, the end plate 230 of the slide body 210 has not yet contacted the lock plate 260. FIG. 16 shows the edge 222 of the slide body 210 engaging the thin section 252 of the angled pathway 250. FIG. 17 is a perspective view of the thin section 252 and the thick section 254 of the angled pathway 250. FIG. 18 is a sectional view that shows the slide body 210 in a position where the end plate 230 contacts the lock plate 260 and the hole 232 in the end plate 230 aligns with the hole 262 in the lock plate 260.

FIGS. 16 and 18 show a seal portion, for example, a seal, 500 that is configured to be received in a base seal receiving portion 510 of the base 100, and is configured to be received in a cover seal receiving portion 520 of the cover 110. The example shown in FIGS. 16 and 18 show the base seal receiving portion 510 and the cover seal receiving portion 520 located such that at least a portion of the seal 500 is located between the angled pathway 250 and the lower pathway 251 (and thus between the upper and lower edges 222 (when the slide body 210 is engaged with the angled pathway 250 and the lower pathway 251. This relative position of the slide body 210 relative to the seal 500 improves the sealing quality of the ODB 10 because the clamping force is at least partially above the seal 500.

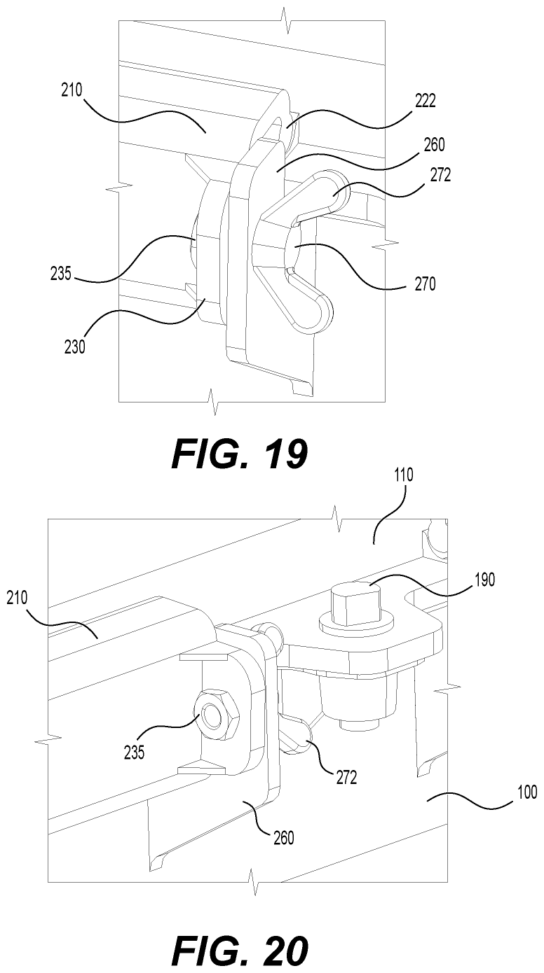

FIG. 19 shows another angle of the position shown in FIG. 18 and shows the winged bolt 270 tightened against the lock plate 260. In the position shown in FIG. 19, the end plate 230 of the slide body 210 is in contact with the lock plate 260 and the winged bolt 270 is fully tightened into the nut 235. In this position, the edge 222 of the slide body 210 is fully engaged with the thick section 254 of the angled pathway 250 and the cover 110 is fully pressed against the base 100. FIG. 20 shows the condition shown in FIG. 19 and shows the bolt 190 used to further secure the cover 110 to the base 100.

The end plate 230 being configured to be directly secured to the lock plate 260 provides a secure direct locking of the slide body 210 to, in this example, the base 100. This can avoid the need for additional parts, and prevents the sealing mechanism (the slide body 210) from moving relative to the base 100.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. An optical distribution box, comprising:
a base portion;
a cover portion configured to be attached to the base portion;
an engaging portion configured to be slidingly attached to a first one of the base portion and the cover portion;
a securing portion configured to secure the engaging portion to one of the base portion and the cover portion in a fully engaged position;
a seal portion configured to be located between the cover portion and the base portion;
wherein a second one of the base portion and the cover portion comprises an angled pathway portion;
wherein at least a portion of the seal portion is located between the angled pathway portion and the first one of the base portion and the cover portion;
wherein the cover portion is configured to be hingedly attached to the base portion;
wherein the cover portion is structurally configured to provide access to the interior of the base portion when the cover portion is in an open position;
wherein the cover portion is structurally configured to prevent access to the interior of the base portion when the cover portion is in a closed position;
wherein the angled pathway portion comprises a first portion and a second portion;
wherein the angled pathway portion transitions from the first portion to the second portion;
wherein the engaging portion comprises a slide body portion configured to slide from the first portion to the second portion;
wherein the slide body portion comprises an edge portion configured to engage the first portion and the second portion of the angled pathway portion;
wherein the slide body portion is configured to urge the cover portion toward the base portion when the slide body portion is moved from the first portion to the second portion; and
wherein the slide body portion is configured to urge the cover portion toward the base portion in a location of the seal portion so as to enhance a watertight seal between the cover portion and the base portion in the fully engaged position of the slide body portion.

2. The optical distribution box of claim 1, wherein the securing portion is fixed to the engaging portion.

3. The optical distribution box of claim 1, wherein the securing portion is configured as an integral part of the engaging portion.

4. The optical distribution box of claim 1, wherein the edge portion of the slide body portion comprises a first edge portion, and the slide body portion comprises a second edge portion.

5. The optical distribution box of claim 4, wherein the first one of the base portion and the cover portion comprises a second edge portion receiving portion that is configured to receive the second edge portion of the slide body portion.

6. The optical distribution box of claim 5, wherein the second edge portion receiving portion is configured to permit the second edge portion to rotate relative to the first one of the base portion and the cover portion so as to alternatively position the angled pathway portion between the first edge portion and the second edge portion.

7. The optical distribution box of claim 1, wherein movement of the slide body portion from the first portion to the second portion of the angled pathway portion compresses the seal portion between the cover portion and the base portion.

8. The optical distribution box of claim 1, further comprising an angled mounting bracket configured to be attached to an interior of the base portion;
wherein the angled mounting bracket comprises a base plate configured to be attached to an interior wall of the base;
wherein the angled mounting bracket comprises an angled extension that extends from the base plate at an angle between zero degrees and ninety degrees; and
wherein the angled extension is configured to receive a mount that is configured to receive a plurality of modules and/or trays.

9. An optical distribution box, comprising:
a base portion;
a cover portion configured to be attached to the base portion;
an engaging portion configured to be attached to a first one of the base portion and the cover portion;
a seal portion configured to be located between the cover portion and the base portion;
wherein a second one of the base portion and the cover portion comprises an angled pathway portion;
wherein at least a portion of the seal portion is located between the angled pathway portion and the first one of the base portion and the cover portion;
wherein the angled pathway portion transitions from a first portion to a second portion;
wherein an edge portion of the engaging portion is configured to engage the first portion and the second portion of the angled pathway portion;
wherein the engaging portion is configured to urge the cover portion toward the base portion when the engaging portion is moved from the first portion to the second portion; and
wherein the engaging portion is configured to urge the cover portion toward the base portion in a location of the seal portion so as to enhance a watertight seal between the cover portion and the base portion in a fully engaged position of the engaging portion.

10. The optical distribution box of claim 9, further comprising a securing portion configured to secure the engaging portion to one of the base portion and the cover portion in the fully engaged position.

11. The optical distribution box of claim 9, wherein the cover portion is configured to be hingedly attached to the base portion.

12. The optical distribution box of claim 9, wherein the cover portion is structurally configured to provide access to the interior of the base portion when the cover portion is in an open position, and wherein the cover portion is structurally configured to prevent access to the interior of the base portion when the cover portion is in a closed position.

13. The optical distribution box of claim 9, wherein the engaging portion comprises a slide body portion configured to slide from the first portion to the second portion of the angled pathway portion.

14. The optical distribution box of claim 13, wherein the slide body portion comprises an edge portion configured to engage the first portion and the second portion of the angled pathway portion.

15. The optical distribution box of claim 14, wherein the edge portion of the slide body portion comprises a first edge portion, and the slide body portion comprises a second edge portion.

16. The optical distribution box of claim 15, wherein the first one of the base portion and the cover portion comprises a second edge portion receiving portion that is configured to receive the second edge portion of the slide body portion, and wherein the second edge portion receiving portion is configured to permit the second edge portion to rotate relative to the first one of the base portion and the cover portion so as to alternatively position the angled pathway portion between the first edge portion and the second edge portion.

17. An optical distribution box, comprising:
a base portion;
a cover portion configured to be attached to the base portion;
an engaging portion configured to be attached to a first one of the base portion and the cover portion;
wherein a second one of the base portion and the cover portion comprises an angled pathway portion;
wherein the base portion and the cover portion are configured to receive a seal portion so that at least a portion of the seal portion is located between the angled pathway portion and the first one of the base portion and the cover portion;
wherein the angled pathway portion transitions from a first portion to a second portion;
wherein an edge portion of the engaging portion is configured to engage the first portion and the second portion of the angled pathway portion; and
wherein the slide body portion is configured to urge the cover portion toward the base portion in a location of the seal portion so as to enhance a watertight seal between the cover portion and the base portion.

18. The optical distribution box of claim 17, wherein the first portion is thinner in a first direction than the second portion.

19. The optical distribution box of claim 17, wherein the engaging portion comprises a slide body portion.

20. The optical distribution box of claim 19, wherein the slide body portion is configured to urge the cover portion toward the base portion when the slide body portion is moved from the first portion to the second portion.

21. The optical distribution box of claim 20, further comprising a securing portion configured to secure the engaging portion to one of the base portion and the cover portion in a fully engaged position.

22. The optical distribution box of claim 21, wherein the securing portion comprises a winged bolt and a nut, the nut is fixed to the slide body portion, and the slide body portion is pulled toward the thick portion of the angled pathway by the securing portion engaging the nut.

23. The optical distribution box of claim 17, wherein the slide body portion comprises a first edge portion configured to engage the first portion and the second portion of the angled pathway portion, and the slide body portion comprises a second edge portion.

24. The optical distribution box of claim 23, wherein the first one of the base portion and the cover portion comprises a second edge portion receiving portion that is configured to receive the second edge portion of the slide body portion, and wherein the second edge portion receiving portion is configured to permit the second edge portion to rotate relative to the first one of the base portion and the cover portion so as to alternatively position the angled pathway portion between the first edge portion and the second edge portion.
